(19) United States
(12) Patent Application Publication
(10) Pub. No.: US 2025/0301947 A1
(43) Pub. Date: Oct. 2, 2025

(54) LAWN MOWER

(71) Applicant: HONDA MOTOR CO., LTD., Tokyo (JP)

(72) Inventors: Yuta MIZUNO, Wako-shi (JP); Rina AKUNE, Wako-shi (JP); Keisuke MATSUBARA, Wako-shi (JP); Shin MURAKAMI, Wako-shi (JP); Yuko NISHI, Wako-shi (JP); Shimpei ONO, Wako-shi (JP)

(21) Appl. No.: 18/620,193

(22) Filed: Mar. 28, 2024

(51) Int. Cl. A01D 34/00; A01D 34/78; A01D 101/00

(52) U.S. Cl. CPC A01D 34/006; A01D 34/78; A01D 2101/00

(57) ABSTRACT

A lawn mower controls a plurality of motors to rotationally drive a plurality of blades in a manner so that the blades rotate while a phase relationship between the vane portions of mutually adjacent blades, from among the plurality of blades, is maintained at a predetermined phase angle.

### BACKGROUND OF THE INVENTION

### Field of the Invention

The present invention relates to a lawn mower for cutting grass.

### Description of the Related Art

In recent years, efforts directed toward realizing a low-carbon society or a decarbonized society have become more active, and research and development in relation to electrification technology are also being conducted in order to reduce CO₂ emissions and to improve energy efficiency.

For example, in JP 2014-195360 A, a riding electric lawn mower is disclosed. This riding electric lawn mower is equipped with three rotating blades arranged in a vehicle widthwise direction. In the publication, it is disclosed that mutual rotational speeds of the three rotating blades can be synchronized to be the same, or alternatively, that the mutual rotational speeds can be made different from one another (refer to paragraph of JP 2014-195360 A).

### SUMMARY OF THE INVENTION

In such a lawn mower, a more accurate rotational control of the plurality of blades is desired.

The present invention has the object of solving the aforementioned problem.

An aspect of the present disclosure is characterized by a lawn mower, including a plurality of blades each including a vane portion on at least one end, a plurality of motors configured to rotationally drive the blades, respectively, a rotational position sensor configured to acquire respective rotational position information when the respective motors rotate, and at least one processor configured to execute computer-executable instructions that are stored in a memory, wherein, by the computer-executable instructions being executed by the at least one processor, the lawn mower controls the plurality of motors in a manner so that the plurality of blades rotate while a phase relationship between the vane portions of mutually adjacent blades from among the plurality of blades is maintained at a predetermined phase angle.

In this manner, the respective motors that cause the respective blades to rotate are controlled in a manner so that the blades rotate while the phase relationship between the vane portions of the mutually adjacent blades of the lawn mower is maintained at the predetermined phase angle. Therefore, the rotational control of each of the blades is made accurate.

The above and other objects, features, and advantages of the present invention will be easily understood from the following description of an embodiment when taken in conjunction with the accompanying drawings.

### BRIEF DESCRIPTION OF THE DRAWINGS

FIG. 1 is a schematic electrical block diagram of a lawn mower according to an embodiment;

FIG. 2 is a schematic perspective view of the lawn mower as seen from a left side thereof;

FIG. 3 is a schematic diagram of the lawn mower including a traveling mechanism and a lawn mowing mechanism when viewed from above the lawn mower;

FIG. 4 is a perspective view of a blade attached to the lawn mower;

FIG. 5A is a perspective view of a working unit housing that is capable of accommodating the blade;

FIG. 5B is a bottom surface view showing a state in which three blades are accommodated in the working unit housing;

FIG. 6 is a main flowchart provided to explain operations of the lawn mower according to the embodiment;

FIG. 7 is a subroutine flowchart;

FIG. 8A is an explanatory diagram showing a first phase relationship in a state in which a master blade is positioned in parallel to a vehicle widthwise direction, and first and second slave blades that are adjacent thereto are positioned in parallel to a front-rear direction;

FIG. 8B is another explanatory diagram showing the first phase relationship in which, respectively, the master blade advances 45 degrees, the second slave blade adjacent to a right side advances 135 degrees, and the first slave blade adjacent to a left side advances 315 degrees in a clockwise direction from the state shown in FIG. 8A with respect to the vehicle widthwise direction;

FIG. 9A is an explanatory diagram showing a second phase relationship in a state in which all three blades are positioned parallel to each other in the front-rear direction;

FIG. 9B is another explanatory diagram showing the second phase relationship in a state in which all three blades have advanced 45 degrees in a clockwise direction with respect to the front-rear direction;

FIG. 9C is another explanatory diagram showing the second phase relationship in a state in which all three blades have advanced 135 degrees in a clockwise direction with respect to the front-rear direction;

FIG. 10 is an explanatory diagram briefly illustrating an example of operations of the lawn mower described in accordance with the above-described embodiment;

FIG. 11A is an explanatory diagram of a blade arrangement according to the embodiment;

FIG. 11B is an explanatory diagram of a blade arrangement according to an Exemplary Modification 1 in which the master blade positioned in the center is positioned in the traveling direction more rearwardly than adjacent slave blades that rotate in following relation thereto;

FIG. 11C is an explanatory diagram of a blade arrangement according to an Exemplary Modification 2 in which the master blade is positioned at an end part;

FIG. 12A is an explanatory diagram of a blade arrangement according to an Exemplary Modification 3, which is made up from two blades;

FIG. 12B is an explanatory diagram of a blade arrangement according to an Exemplary Modification 4, which is made up from four blades; and

FIG. 12C is an explanatory diagram of a blade arrangement according to an Exemplary Modification 5, which is made up from four blades.

### DESCRIPTION OF PREFERRED EMBODIMENTS

### Embodiments

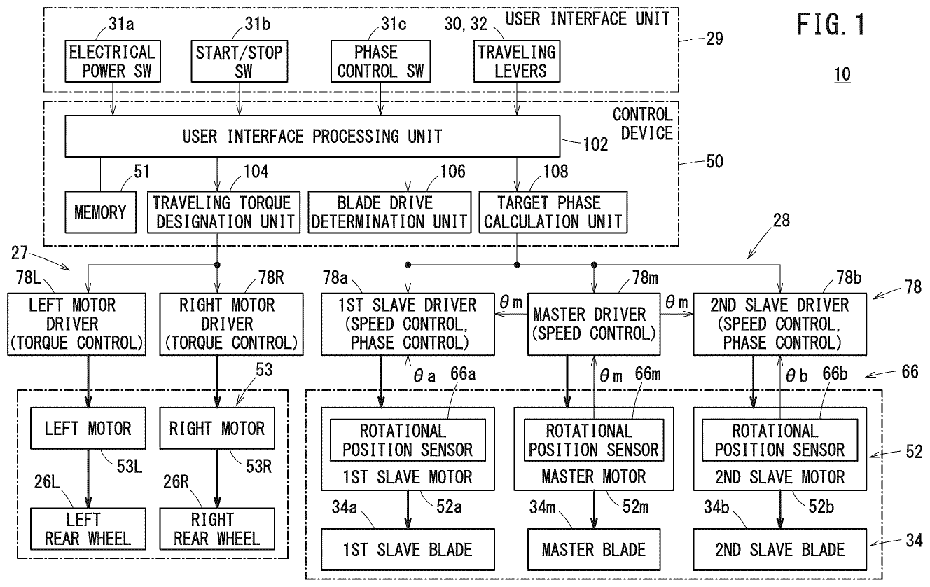

FIG. 1 is a schematic electrical block diagram of a lawn mower 10 according to an embodiment.

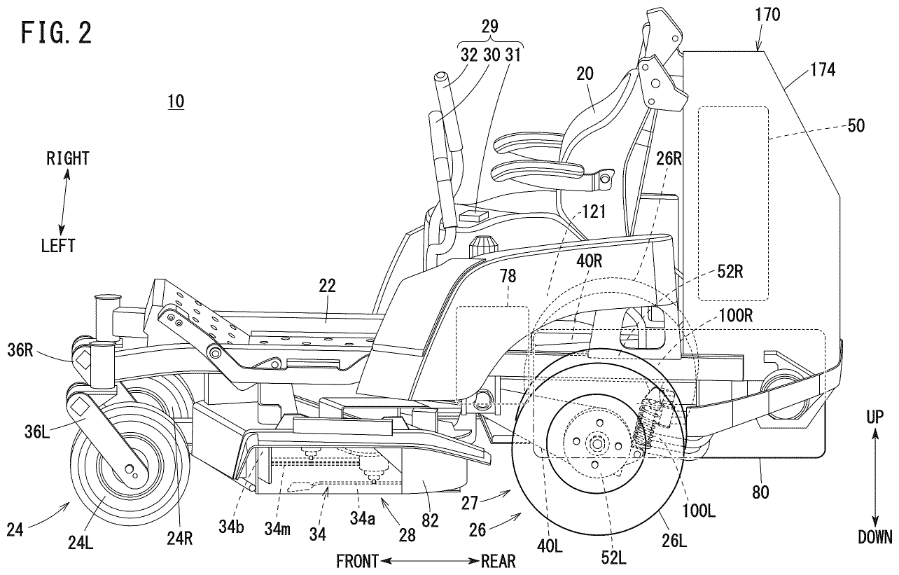

FIG. 2 is a schematic perspective view of the lawn mower 10 as seen from a left side thereof.

The lawn mower 10 is configured to be capable of traveling autonomously without the need for a worker such as a driver, and together therewith, is configured to be capable of traveling manually by the worker serving as the driver.

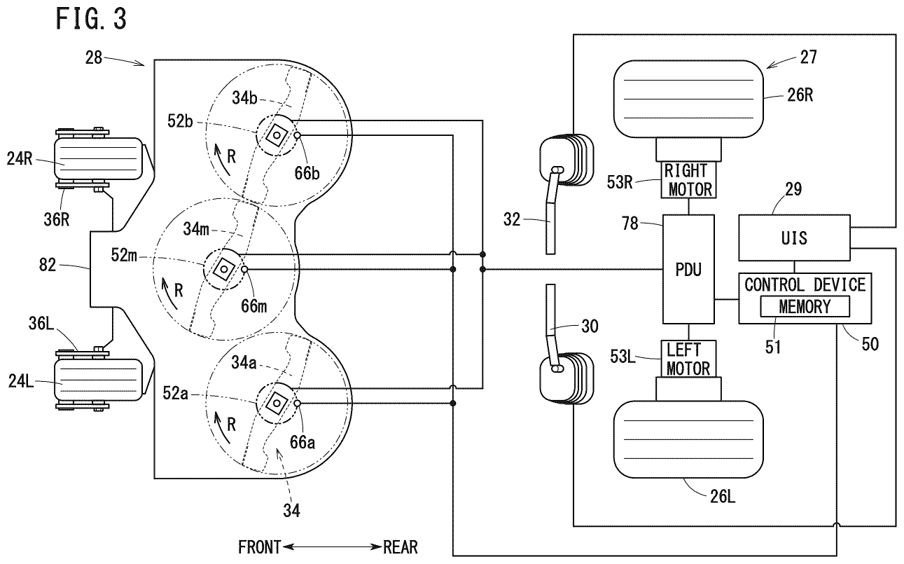

FIG. 3 is a schematic diagram of the lawn mower 10 including a traveling mechanism 27 and a lawn mowing mechanism 28 when viewed from above the lawn mower 10.

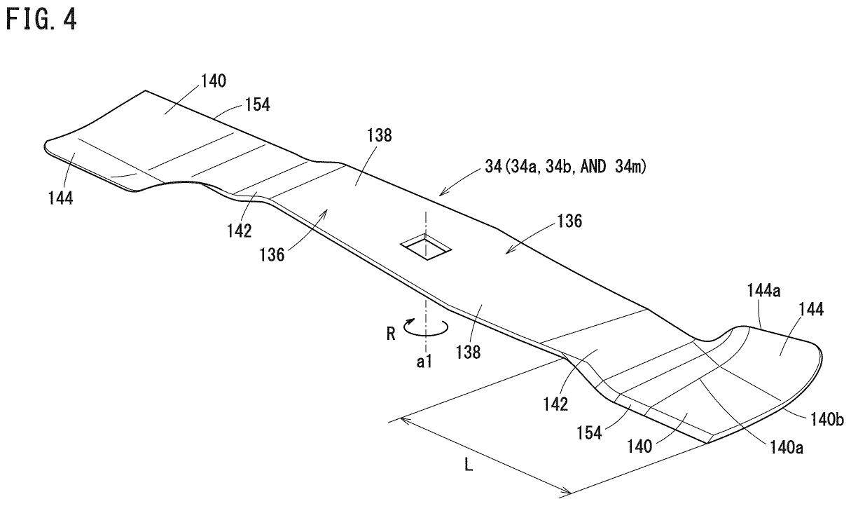

FIG. 4 is a perspective view of a blade 34 that is attached to the lawn mower 10.

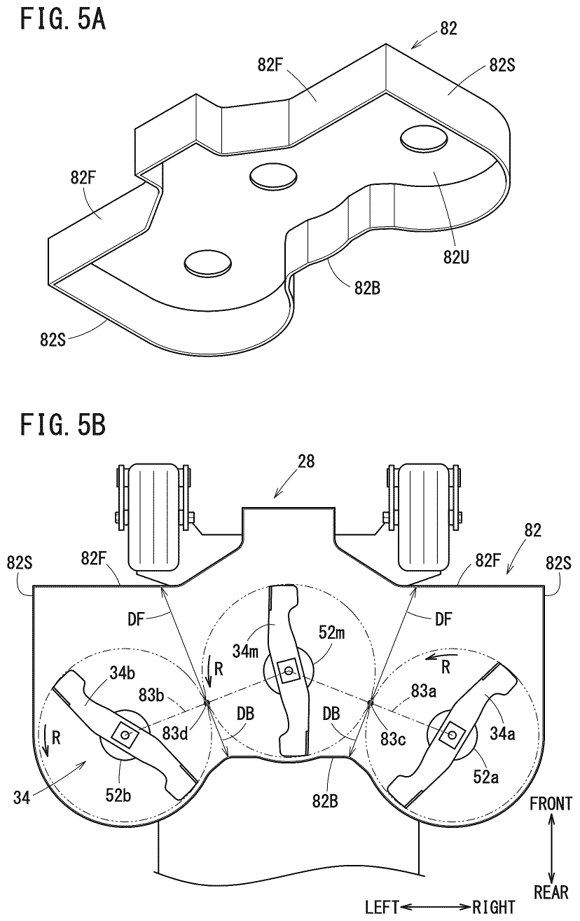

FIG. 5A is a perspective view of a working unit housing 82 that is capable of accommodating the blades 34.

FIG. 5B is a bottom surface view showing a state in which three of the blades 34 (34a, 34b, and 34m) are accommodated in the working unit housing 82.

The lawn mowing mechanism 28 includes the blades 34 (34a, 34b, and 34m), and the working unit housing 82 in which the blades 34 (34a, 34b, and 34m) are accommodated.

As shown in FIG. 5B, the blades 34 (34a, 34b, and 34m) are connected via blade holders to output shafts of working motors 52 (52a, 52b, and 52m), and are rotated by rotational driving forces being transmitted from the output shafts.

Axes of rotation (also referred to as blade rotational axes) a1 of the blades 34 (34a, 34b, and 34m) shown in FIG. 4 coincide with output axes (axes of rotation) of the working motors 52 as shown in FIG. 5B.

As shown in FIG. 4, the blades 34 are plate-shaped elongated members (so-called bar blades) that extend in a direction perpendicular to the axes of rotation a1 (also referred to as the blade rotational axes) of the blades 34. Moreover, in the following description, the direction of the blades 34 is a lengthwise direction of the bar blades, which is also referred to as a diametrical direction.

Each of the blades 34 includes a pair of blade arms 136 that are extended in opposite directions from each other about the blade rotational axis a1. The pair of blade arms 136 is configured to be axially symmetrical with respect to the blade rotational axis a1.

Each of the blades 34 (34a, 34b, and 34m) is caused to be rotated at the same rotational speed by each of the working motors 52 (52a, 52b, and 52m) in a same direction of rotation R (a clockwise direction when viewed from above, a counterclockwise direction when viewed from below).

Each of the blade arms 136 comprises a blade base portion 138 formed along the diametrical direction of the blade 134, a cutting portion 140 located diametrically more outward than the blade base portion 138 is, a descending portion 142 formed between the blade base portion 138 and the cutting portion 140, and a vane portion 144 extending from the cutting portion 140 in a counter-rotational direction.

The cutting portion 140 is continuous with the outer end part in the diametrical direction of the descending portion 142, and constitutes an outside region in the diametrical direction of the blades 34. The cutting portion 140 is positioned more downward than the blade base portion 138 and the descending portion 142. The cutting portion 140 is inclined in a manner so as to descend toward the outer side in the diametrical direction. Accordingly, the outer end part 140b in the diametrical direction of the cutting portion 140 is positioned more downward than an inner end part 140a in the diametrical direction of the cutting portion 140.

The descending portion 142 is a portion that bends downwardly from the blade base portion 138 toward the diametrical outward direction. The descending portion 142 is continuous with the inner end part 140a in the diametrical direction of the cutting portion 140.

The vane portion 144 projects out more in the counter-rotational direction than the blade base portion 138. The vane portion 144 is formed in a manner so as to rise up from the cutting portion 140 in the counter-rotational direction. When viewed in the axial direction along the blade rotational axis a1, an upper end part 144a of the vane portion 144 is aligned (substantially in parallel with) a blade portion 154.

The height at which the vane portion 144 rises up from the cutting portion 140 becomes greater toward the diametrical outward direction.

By rotating along the direction of rotation R of the blades 34, each of circles (refer to FIG. 3) indicated by the two-dot dashed lines is formed by the outer end parts 140b in the diametrical direction of the cutting portions 140 that connect to the vane portions 144. Each of the circles is substantially on the same plane.

In accordance with the rotation of the blades 34, an ascending air flow is generated in front and behind in the direction of rotation of the vane portions 144. Further, the rotation of the blades 34 generates an air flow (referred to as a diametrically outward directed air flow) that flows in the diametrical direction from the inner circumferential sides of the vane portions 144 to the outer circumferential side (the outer end part 140b in the diametrical direction) of the vane portions 144. The ascending air flow and the diametrically outward directed air flow merge together rearwardly of the vane portions 144 during rotation, and become an air flow (referred to as a rearwardly directed air flow) that flows in a rearward direction.

On front edges in the direction of rotation R of both end parts of the blade 34, blade portions 154 having sharp cutting edges are formed. The blade portions 154 are bent at a connected location between the cutting portions 140 and the descending portions 142. The blade portions 154 have an effective blade length L.

### Mechanical Configuration of Lawn Mower 10

In FIG. 2, the left direction and the right direction refer to the left and right directions of a worker (not shown) as a driver who is seated on a seat 20 of the lawn mower 10. The left-right direction is synonymous with a vehicle widthwise direction. The front-rear direction is a horizontal direction that is perpendicular with respect to the vehicle widthwise direction, and is synonymous with a vehicle lengthwise direction (a length of the lawn mower 10). The upper-lower direction is a vertical direction that is perpendicular to the vehicle widthwise direction and the vehicle lengthwise direction, and is synonymous with a vehicle heightwise direction.

The lawn mower 10 includes a vehicle body frame 22, a pair of front wheels 24 (a left front wheel 24L and a right front wheel 24R) which are driven wheels, and a pair of rear wheels 26 (a left rear wheel 26L and a right rear wheel 26R) which are driving wheels that constitute the traveling mechanism 27, and the lawn mowing mechanism 28.

The lawn mowing mechanism 28 is positioned downwardly of the vehicle body frame 22, and positioned between the front wheels 24 and the rear wheels 26, in the front-rear direction.

The lawn mowing mechanism 28 includes the working unit housing 82 which is shown partially cut away.

As shown in FIG. 5A, the working unit housing 82 is constituted from an upper wall 82U, and a front side wall 82F, a rear side wall 82B, and left and right side walls 82S that are connected perpendicularly to the upper wall 82U.

The working unit housing 82 is formed symmetrically to the left and right with respect to the front-rear direction of a center line in the vehicle widthwise direction.

The three blades 34 (34a, 34b, and 34m) are accommodated inside of a space (an accommodation unit) formed by the upper wall 82U, the rear side wall 82B, and the left and right side walls 82S. Left and right blades 34a and 34b are disposed on both sides of a central blade 34m.

The blade 34m (referred to as a master blade) is attached to an output shaft (an axis of rotation) of the central working motor (also referred to as a master motor) 52m, and the left and right blades 34a and 34b (referred to as slave blades) are attached to axes of rotation of the left and right working motors (also referred to as slave motors) 52a and 52b.

In the working unit housing 82, a distance DF from a midpoint 83c on a straight line 83a connecting the centers of rotation of the mutually adjacent first slave blade 34a and the master blade 34m to the front side wall 82F is longer than a distance DB from the midpoint 83c to the rear side wall 82B.

Similarly, in the working unit housing 82, a distance DF from a midpoint 83d on a straight line 83b connecting the centers of rotation of the mutually adjacent second slave blade 34b and the master blade 34m to the front side wall 82F is longer than a distance DB from the midpoint 83d to the rear side wall 82B.

Returning to FIG. 2 and FIG. 3, the left rear wheel 26L and the right rear wheel 26R, respectively, are rotationally driven by a left motor (a left traveling motor) 53L and a right motor (a right traveling motor) 53R.

The lawn mower 10 is further equipped with a pair of traveling levers (control levers) 30 and 32, a battery 80, and an autonomous control unit 170.

The autonomous control unit 170 includes a control device 50, and a housing 174 in which the control device 50 is accommodated. The housing 174 is arranged upwardly of the battery 80 at a rear portion of the lawn mower 10.

The worker sits on the seat 20, and operates the traveling levers 30 and 32. Accompanying this operation, the lawn mower 10 moves forward, moves rearward, stops or turns, or alternatively, the lawn mowing mechanism 28 moves upward and downward, or the three individual blades 34 (34a, 34b, and 34m) provided in the lawn mowing mechanism 28 rotate or stop.

For example, by the traveling levers 30 and 32 being operated to rotate the pair of left and right rear wheels 26 in the forward direction at the same number of revolutions, the lawn mower 10 moves forward, and by the pair of left and right rear wheels 26 being rotated in the rearward direction at the same number of revolutions, the lawn mower 10 moves rearward.

By the pair of left and right rear wheels 26 being rotated at the same number of revolutions and in different directions, the lawn mower 10 can change its orientation (turn) on the spot without moving forward or moving rearward, or in other words, can perform a so-called spin turn.

Moreover, in the case of turning right (making a right turn) or turning left (making a left turn) without stopping, each of the wheel velocities of the rear wheels 26R and 26L may be adjusted, in a manner so as to bring about a predetermined angular speed (turning speed).

The left front wheel 24L and the right front wheel 24R are connected respectively to the vehicle body frame 22 via a left front fork 36L and a right front fork 36R. In this case, since the left front fork 36L and the right front fork 36R are pivotally supported by the vehicle body frame 22, the left front wheel 24L and the right front wheel 24R can be freely turned leftward or rightward.

The left rear wheel 26L is connected to the vehicle body frame 22 via a left swing arm 40L and a left suspension 100L. The right rear wheel 26R is connected to the vehicle body frame 22 via a right swing arm 40R and a right suspension 100R.

A PDU (Power Drive Unit) 78, which is a motor driver, is arranged in a space 121 surrounded by the vehicle body frame 22 and under the seat 20.

### Electrical Circuit of Lawn Mower 10

Next, with reference to FIG. 1 and FIG. 3, a description will be given concerning the electrical circuit connections of the lawn mower 10.

The lawn mower 10 includes a user interface unit 29, the control device 50, the traveling mechanism 27, and the lawn mowing mechanism 28.

The user interface unit 29 includes an electrical power source switch 31a, a start/stop switch 31b, a phase control switch 31c, and the traveling levers 30 and 32.

The control device 50 includes a user interface processing unit 102, a memory 51, a traveling torque designation unit 104, a blade drive determination unit 106, and a target phase calculation unit 108.

The traveling mechanism 27 includes a left motor driver 78L that drives the left motor 53L that causes the left rear wheel 26L to rotate, and a right motor driver 78R that drives the right motor 53R that causes the right rear wheel 26R to rotate.

The lawn mowing mechanism 28 includes a first slave driver 78a that drives the first slave motor 52a that causes the first slave blade 34a to rotate, a second slave driver 78b that drives the second slave motor 52b that causes the second slave blade 34b to rotate, and a master driver 78m that drives the master motor 52m that causes the master blade 34m to rotate.

By the electrical power source switch 31a being turned ON, the electrical power from the battery 80 is supplied to each of respective components, and by the electrical power source switch 31a being turned OFF, the supply of the electrical power from the battery 80 to each of the respective components is stopped.

A start/stop switch 31s is provided on the traveling lever 30 or 32, which by being turned ON causes the three blades 34 to rotate simultaneously, and by being turned OFF causes the rotation of the three blades 34 to stop.

The phase control switch 31c carries out switching between an energy saving mode (a noise suppression control) and a power mode (an emission control), which will be described later. Moreover, in the present embodiment, the switching between the modes is carried out automatically by the control device 50. Such switching can also be carried out manually.

As described above, the traveling levers 30 and 32 cause the traveling mechanism 27 and the lawn mowing mechanism 28 to be operated.

The control device 50 is constituted by a computer having at least one processor (CPU), the memory 51 (a storage device), an input/output interface, and an electronic circuit. The at least one processor (CPU) operates as various functional units by executing computer-executable instructions such as programs or the like that are stored in the memory.

Specifically, the control device 50 operates as the user interface processing unit 102, the traveling torque designation unit 104, the blade drive determination unit 106, and the target phase calculation unit 108.

Five individual motor drivers 78 (78a, 78b, 78m, 78L, and 78R) are controlled by the control device 50.

The control device 50 acquires operation data of the user interface unit 29 via the user interface processing unit 102, and controls the traveling mechanism 27 via the traveling torque designation unit 104, together with controlling the lawn mowing mechanism 28 through the blade drive determination unit 106 and the target phase calculation unit 108.

The left motor driver 78L that constitutes the traveling mechanism 27 electrically drives the left motor 53L, which rotationally drives the left rear wheel 26L by a torque control.

The right motor driver 78R that constitutes the traveling mechanism 27 electrically drives the right motor 53R, which rotationally drives the right rear wheel 26R by a torque control.

In this case, in the torque control, the control device 50 controls an electrical current value of traveling motors 53 (53L and 53R) through the motor drivers 78 (78L and 78R), in a manner so that the torque, which was specified by the traveling torque designation unit 104 based on the operations of the traveling levers 30 and 32, is output from the traveling motors 53 (53L and 53R).

The lawn mowing mechanism 28 is equipped with a motor driver 78 having a master driver 78m, a first slave driver 78a, and a second slave driver 78b.

The master driver 78m electrically drives the master motor 52m, which rotationally drives the master blade 34m, by controlling the speed thereof.

The first slave driver 78a electrically drives the first slave motor 52a, which rotationally drives the first slave blade 34a, by controlling the speed and controlling the phase thereof.

The second slave driver 78b electrically drives the second slave motor 52b, which rotationally drives the second slave blade 34b, by controlling the speed and controlling the phase thereof.

In this case, in the speed control, the control device 50 carries out a speed control of the motor drivers 78 (78a, 78b, and 78m), in a manner so that the blades 34 (34a, 34b, and 34m) rotate at a predetermined rotational speed (a target rotational speed) [rpm].

Further, in the phase control of the power mode, an angular control of the motor drivers 78 (78a, 78b, and 78m) is carried out, in a manner so that the master motor 52m, the first slave motor 52a, and the second slave motor 52b rotate synchronously in the same direction and with the same phase.

Furthermore, in the phase control of the energy saving mode, an angular (a slave phase) control by the first slave driver 78a and the second slave driver 78b is carried out, in a manner so that the master motor 52m is set as a master phase (a reference phase), and a phase (a slave phase) of the first slave motor 52a and a phase (a slave phase) of the second slave motor 52b rotate synchronously in the same direction in a state with a 90-degree phase shift (a phase difference of 90 degrees) being applied with respect to the master phase.

Moreover, in the energy saving mode, a phase angle (a phase difference) of the slave phase with respect to the master phase is not limited to being 90 degrees, and for example, can be set within a range of 90 degrees±30 degrees, and more preferably, within a range of 90 degrees±15 degrees. Further, the phase difference can also be set in a manner so as to change continuously or in a stepwise manner in accordance with a workload in the energy saving mode.

The first slave motor 52a, the second slave motor 52b, and the master motor 52m each function respectively as the working motors 52.

Each of the master motor 52m, the first slave motor 52a, and the second slave motor 52b include, respectively, a rotational position sensor 66m, a rotational position sensor 66a, and a rotational position sensor 66b that detect the angles of rotation (phases) of the master blade 34m, the first slave blade 34a, and the second slave blade 34b.

According to the present embodiment, rotational position sensors 66 (66a, 66b, and 66m) are semiconductor-type rotational position sensors (displacement sensors) that make use of semiconductor magnetoresistance elements. The rotational position sensors 66 are sensors that detect a strength or weakness of the external magnetic fields of the rotors of each of the working motors 52, and thereby accurately detect the angles of rotation θ (θa, θb, and θm) (rotational position information indicating how many degrees the angles of the axes of rotation are from 0 degrees).

Each of the rotational position sensors 66, respectively, outputs a three-phase (A-phase, B-phase, and Z-phase) signal. These are well-known sensors by which the directions of rotation are detected based on a phase difference between an A-phase signal and a B-phase signal of the rotational position sensors 66, and by which an origin point based on a Z-phase signal is output one time per one rotation.

The rotational position information θm of the rotational position sensor 66m is acquired by the master driver 78m.

The rotational position information θa of the rotational position sensor 66a is acquired by the first slave driver 78a.

The rotational position information θb of the rotational position sensor 66b is acquired by the second slave driver 78b.

The rotational position information θ (θa, θb, and θm) also serves as the rotational position information θ of the blades 34 (34a, 34b, and 34m) that are connected to the output shafts of the working motors 52.

The rotational position information θm of the master blade 34m, which is detected by the rotational position sensor 66m of the master motor 52m, is supplied to the first slave driver 78a and the second slave driver 78b via the master driver 78m, in a manner so as to be shared by the first slave blade 34a and the second slave blade 34b.

Moreover, the rotational position sensors 66 (66a, 66b, and 66m) may be provided on the blades 34 (34a, 34b, and 34m) and not on the working motors 52 (52a, 52b, and 52m), and may be constituted to output the rotational position information θ (θa, θb, and θm) to the motor drivers 78 (78a, 78b, and 78m).

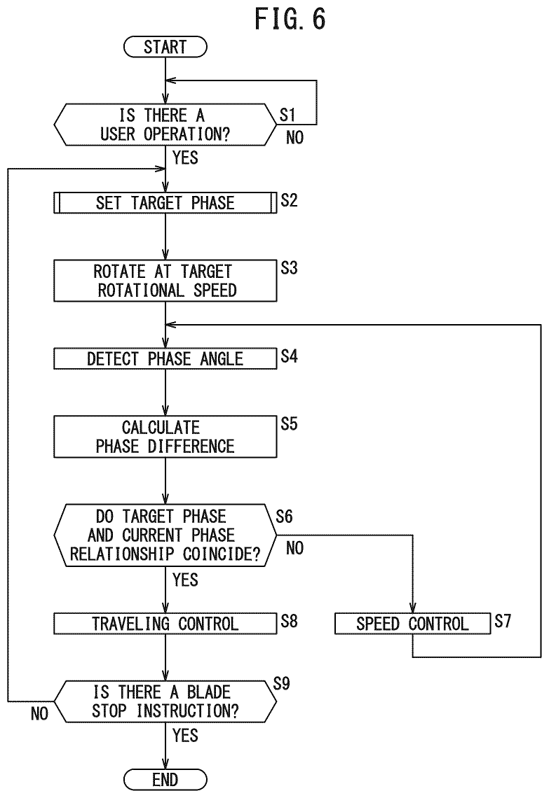

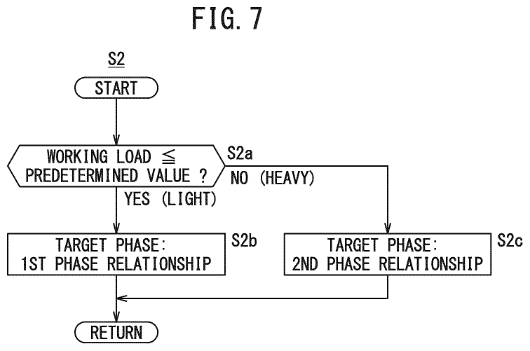

A description will be given with reference to the main flow chart of FIG. 6 and the subroutine flow chart of FIG. 7 concerning operations of the lawn mower 10 which is configured basically in the manner described above.

In step S1, the control device 50 determines through the user interface processing unit 102 whether or not there is an ON operation of the electrical power source switch 31a, and further, whether or not a user operation is performed by the user operating the traveling lever(s) 30 and/or 32 to issue a travel instruction and a rotation instruction (a starting instruction) to rotate the blades 34.

In the case that the control device 50 has determined the presence of the ON operation and the user operation (step S1: YES), the control device 50 advances the process to step S2.

In step S2, the control device 50 advances the process to step S2a of the subroutine process of FIG. 7, in order to determine (set) a target phase to cause the blades 34 to be rotated in either the energy saving mode or the power mode.

In step S2a, the control device 50 determines whether or not the workload is less than or equal to a predetermined value.

The workload is determined by comparing a present degree of density of the grass or the present length of the grass, and a predetermined reference density or a predetermined reference length that has been determined beforehand as a predetermined value.

In this case, the control device 50 acquires the present degree of density of the grass or the present length of the grass based on, for example, images captured by a non-illustrated camera, or alternatively, based on reflected waves obtained by a non-illustrated LiDAR or a non-illustrated radar.

In the case that the inequality “degree of density of grass≤reference density” or “length of grass≤reference length” is satisfied, then the condition of “workload≤predetermined value” is brought about, and the determination of step S2a is affirmative (step S2a: YES). More specifically, the control device 50 determines that the workload is comparatively light, and advances the process to step S2b.

On the other hand, in the case that the inequality “degree of density of grass>reference density” or “length of grass>reference length” is satisfied, then the condition of “workload>predetermined value” is brought about, and the determination of step S2a is negative (step S2a: NO). More specifically, the control device 50 determines that the workload is comparatively heavy, and advances the process to step S2c.

Moreover, it should be noted that the workload can also be determined by means of a motor current value which is proportional to the rotational torque of the master motor 52m during the speed control. In this case, in the case that the measured motor current value is less than or equal to a reference current value (motor current value≤reference current value), the determination of step S2a is affirmative (step S2a: YES), and it is determined that the workload is comparatively light. In the case that the measured motor current value exceeds the reference current value (motor current value>reference current value), the determination of step S2a is negative (step S2a: NO), and it is determined that the workload is comparatively heavy.

In step S2b, the control device 50 employs the energy saving mode, and sets the target phase (the phase difference of the slave blades 34a and 34b with respect to the master blade 34m) to the first phase relationship.

In step S2c, the control device 50 employs the power mode, and sets the target phase to the second phase relationship.

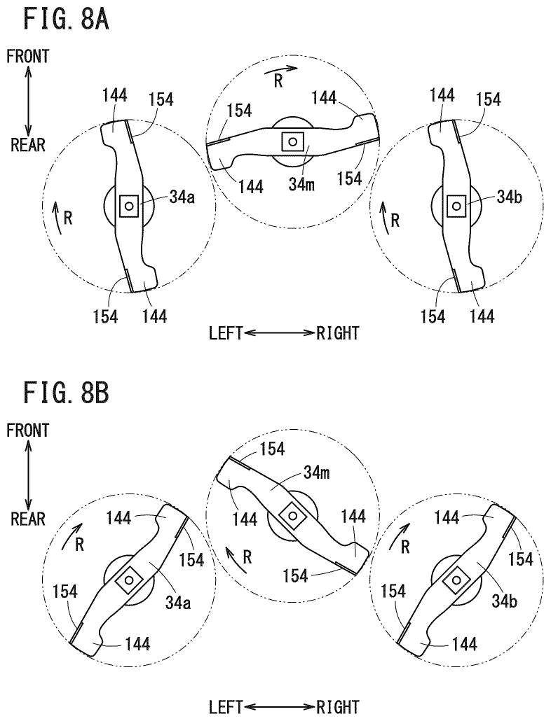

FIG. 8A and FIG. 8B are explanatory diagrams in plan view illustrating, respectively, first phase relationships which are target phases in the energy saving mode that are set in step S2b.

FIG. 8A is an explanatory diagram showing the first phase relationship according to the energy saving mode in which the master blade 34m is positioned in parallel to the left-right direction (the vehicle widthwise direction) and the slave blades 34a and 34b are positioned in parallel to the front-rear direction.

In the first phase relationship, the phase difference of the slave blades 34a and 34b with respect to the master blade 34m is set to 90 degrees.

FIG. 8B is another explanatory diagram showing the first phase relationship in the energy saving mode, in which the master blade 34m, the first slave blade 34a, and the second slave blade 34b are advanced from the state shown in FIG. 8A by 45 degrees in the direction of rotation R from the positions thereof shown in FIG. 8A.

In the first phase relationship, the master motor 52m, the first slave motor 52a, and the second slave motor 52b are rotationally driven, respectively, by the master driver 78m, the first slave driver 78a, and the second slave driver 78b, in a manner so that the first slave blade 34a and the second slave blade 34b which rotate at the target rotational speed are rotated while maintaining a phase shift of 90 degrees (a phase difference of 90 degrees) with respect to the phase of the master blade 34m which rotates at the target rotational speed.

In the first phase relationship, the master driver 78m executes the speed control of the master motor 52m, in a manner so that the master motor 52m rotates at the target rotational speed based on the rotational position information θm detected by the rotational position sensor 66m.

The master driver 78m transmits its own rotational position information θm in real time to the first slave driver 78a and the second slave driver 78b.

In this case, the first slave driver 78a executes the speed control of the first slave motor 52a, in a manner so that the first slave motor 52a rotates at the target rotational speed based on the rotational position information θa detected by the rotational position sensor 66a. Simultaneously therewith, based on the transmitted rotational position information θm and its own rotational position information θa, the first slave driver 78a executes the phase control in a manner so that the first slave motor 52a maintains its rotation with a phase shift of 90 degrees (a phase difference of 90 degrees) with respect to that of the master motor 52m.

Further, at the same time, the second slave driver 78b executes the speed control of the second slave motor 52b, in a manner so that the second slave motor 52b rotates at the target rotational speed based on the rotational position information θb detected by the rotational position sensor 66b. Simultaneously therewith, based on the transmitted rotational position information θm and its own rotational position information θb, the second slave driver 78b executes the phase control in a manner so that the second slave motor 52b maintains its rotation with a phase shift of 90 degrees (a phase difference of 90 degrees) with respect to that of the master motor 52m.

In this instance, in order to more easily understand the advantages of the energy saving mode (the first phase relationship), a problem with a comparative example of a lawn mower provided with a plurality of blades but which is not equipped with the energy saving mode will be described. The lawn mower according to the comparative example, which causes the plurality of blades to rotate simultaneously and at the same phase, cuts the grass by causing each of the blades to be rotated by its corresponding working motor.

The lawn mower according to the comparative example, by a negative pressure due to the vane portions of the blades, causes the grass to stand up and be cut, while on the other hand, a wind (an air flow) generated by the vane portions generates mutual interference between the adjacent blades themselves. Such mutual interference between the blades themselves generates pulsations in the rotation of each of the blades, and as a result, depending on the condition of the grass, generates uneven cutting of the grass. In order to suppress the pulsations of each of the blades, an acceleration and deceleration control of each of the working motors is required.

However, with the lawn mower according to the comparative example, the acceleration and deceleration control of each of the working motors so as to suppress the pulsations of each of the blades increases the electrical power consumption of each of the working motors, and generates vibrations and noise due to variations in the rotational speed.

In contrast thereto, with the lawn mower 10 according to the embodiment, the rotational position information θm of the master motor 52m, which is detected by the rotational position sensor 66m of the master motor 52m, is supplied to the first slave driver 78a and the second slave driver 78b via the master driver 78m.

Consequently, by a speed control that makes use of the rotational position information θa of its own rotational position sensor 66a, and a phase control that makes use of the rotational position information θa and the rotational position information θm, the first slave driver 78a is capable of causing the rotation of the first slave motor 52a to follow along with the rotation of the master motor 52m.

At the same time, by the speed control (using the rotational position information θb) and the phase information (using the rotational position information θb and the rotational position information θm), the second slave driver 78b is capable of causing the rotation of the second slave motor 52b to follow along with the rotation of the master motor 52m.

Specifically, in the energy saving mode (the first phase relationship) described above, the first slave blade 34a and the second slave blade 34b rotate while maintaining a phase shift of 90 degrees (a phase difference of 90 degrees) with respect to the master blade 34m.

Therefore, the positions of the air flows (the aforementioned ascending air flow, the diametrically outward directed air flow, and the rearwardly directed air flow) generated by the vane portions 144 of the master blade 34m, and the air flows (the aforementioned ascending air flow, the diametrically outward directed air flow, and the rearwardly directed air flow) generated by the vane portions 144 of the first slave blade 34a that rotates adjacent thereto are maximally distanced from each other at all times during rotation. Simultaneously, the positions of the air flows generated by the vane portions 144 (the air flows generated in the front-rear direction of the vane portions 144 in the direction of rotation thereof) of the master blade 34m, and the air flows generated by the vane portions 144 of the second slave blade 34b that rotates adjacent thereto are maximally distanced from each other at all times during rotation.

Consequently, an impact due to collisions of the air flows between the blade 34m and the blade 34a (as well as the blade 34m and the blade 34b) during rotation thereof becomes extremely small and a reduction in sound is realized, and further, the torque current required in order to maintain the rotational speed of the working motors (52a, 52b, and 52m) becomes smaller (energy savings is achieved), and as a result, fluctuations in the torque current can be suppressed.

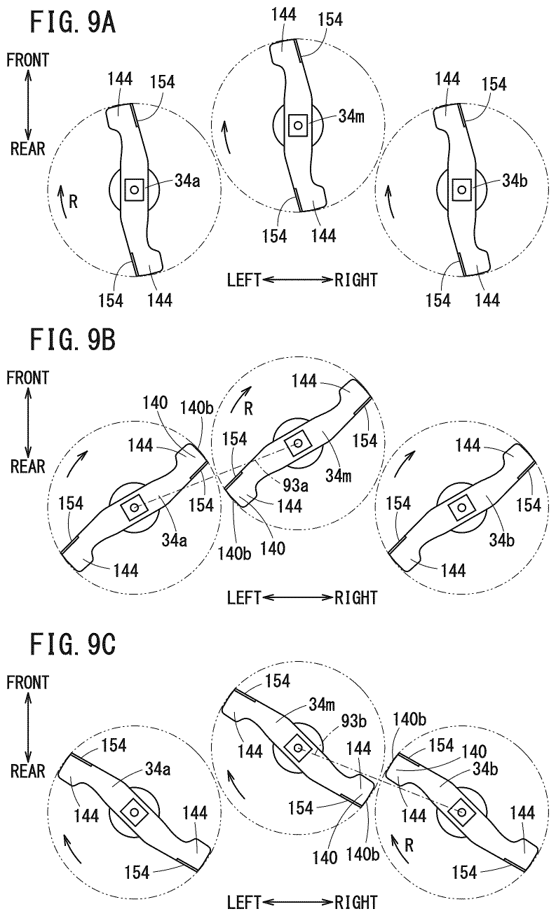

FIG. 9A, FIG. 9B, and FIG. 9C are diagrams illustrating, respectively, second phase relationships which are target phases in the power mode that is set in step S2c.

FIG. 9A is an explanatory diagram showing a state in which all three blades 34 are facing in the front-rear direction.

FIG. 9B is an explanatory diagram showing a state in which all three blades 34 have advanced 45 degrees in the direction of rotation R from the position shown in FIG. 9A.

FIG. 9C is an explanatory diagram showing a state in which all three blades 34 have advanced 135 degrees in the direction of rotation R from the position shown in FIG. 9A.

In the second phase relationships shown in FIG. 9A to FIG. 9C, the master motor 52m, the first slave motor 52a, and the second slave motor 52b are rotationally driven by the master driver 78m, the first slave driver 78a, and the second slave driver 78b, in a manner so that the slave blades 34a and 34b which rotate at the target rotational speed are rotated while maintaining a phase difference of 0 degrees with respect to the phase of the master blade 34m which rotates at the target rotational speed.

When rotated while maintaining the phase difference of 0 degrees, during rotation thereof, the vane portions 144 themselves of the master blade 34m and the first slave blade 34a come closest to and pass by each other (pass close enough to brush against each other while going in opposite directions) on a line 93a (see FIG. 9B) connecting the centers of each of the circles indicated by the two-dot-dashed lines formed by the outer end parts 140b in the diametrical direction of the cutting portions 140 that are connected to the vane portions 144.

Similarly, when rotated while maintaining the phase difference of 0 degrees, during rotation thereof, the vane portions 144 themselves of the master blade 34m and the second slave blade 34b come closest to and pass by each other on a line 93b (see FIG. 9C) connecting the centers of each of the circles indicated by the two-dot-dashed lines formed by the outer end parts 140b in the diametrical direction of the cutting portions 140 that are connected to the vane portions 144.

When they come closest to and pass by each other, the air flows generated by the vane portions 144 of the master blade 34m (the aforementioned ascending air flow, the diametrically outward directed air flow, and the rearwardly directed air flow), and the air flows generated by the vane portions 144 of the first slave blade 34a that rotates adjacent thereto collide when the vane portions 144 themselves come closest to and brush against each other.

A sudden negative pressure is generated within the working unit housing 82 due to such collisions of the air currents (interference between the vane portions 144) at every half rotation of the blades 34.

Therefore, the generation of clumps of grass inside the working unit housing 82 is suppressed, grass clippings can be efficiently discharged from the working unit housing 82 of the lawn mower 10, and the average power consumption of the working motors 52 can be reduced. For this reason, the second phase relationship is also referred to as a discharge mode phase relationship.

In this case, as has been described with reference to FIG. 5A, in the working unit housing 82, the distance DF from the midpoint 83c on the straight line 83a connecting the centers of rotation of the first slave blade 34a and the master blade 34m that rotate side-by-side to the front side wall 82F is longer than the distance DB to the rear side wall 82B, and similarly, the distance DF from the midpoint 83d on the straight line 83b connecting the centers of rotation of the second slave blade 34b and the master blade 34m that rotate side-by-side to the front side wall 82F is longer than the distance DB to the rear side wall 82B.

Therefore, since the positions where the vane portions 144 of the adjacent blades (the master blade 34m and the first slave blade 34a as well as the master blade 34m and the second slave blade 34b) are closest to each other is on the rearward side of the working part housing 82 where the rigidity is high (the space between the vane portions 144 of the blades 34m, 34a, and 34b and the rear side wall 82B is narrow), vibrations generated in the lawn mower 10 can be suppressed.

After the target phase has been set in step S2, the control device 50 advances the process to step S3.

In step S3, the control device 50 executes through the motor drivers 78 (78a, 78b, and 78m), the speed control that causes the working motors 52 (52a, 52b, and 52m) to be rotated at the target rotational speed, whereupon the process proceeds to step S4.

In step S4, the control device 50 detects the phase angles (the rotational positions) of the working motors 52 (52a, 52b, and 52m) by the rotational position sensors 66a, 66b, and 66m, whereupon the process proceeds to step S5.

In step S5, the control device 50 calculates the phase differences (θm−θa, θm−θb) of the master driver 78m, and obtains the current phase relationship with respect to the first slave driver 78a and the second slave driver 78b, whereupon the process proceeds to step S6.

In step S6, the control device 50 determines whether or not the current phase relationship coincides with the target phase {the first phase relationship (θm−θa=θm−θb=90 degrees) or the second phase relationship (θm−θa=θm−θb=0 degrees) determined in step S2} that was set in step S2.

More specifically, it is determined whether or not the current phase relationship between the first slave motor 52a and the second slave motor 52b coincides with the phase of the master motor 52m, and in the case that they do not coincide (step S6: NO), the process proceeds to step S7, whereas in the case that they do coincide (step S6: YES), the process proceeds to step S8.

In step S7, the control device 50 imparts (adds or subtracts) with respect to the first slave motor 52a and the second slave motor 52b a torque with respect to the speed control to reach the target phase, whereupon the process returns to step S4.

In step S8, the control device 50 controls the traveling motors 53 (53L and 53R). In accordance therewith, during traveling, mowing of the grass is executed by the blade 34 in accordance with the energy saving phase or the power phase that was set in step S2, whereupon the process proceeds to step S9.

In step S9, the control device 50 determines whether or not a user operation, which is an instruction to stop the blades 34, is performed by the user, and if there is not an instruction to stop (step S9: NO), the process returns to step S2 and the mowing of the grass until step S8 continues. In the case that there is an instruction to stop (step S9: YES), the current process comes to an end.

As described above, by the control device 50 repeating the control of step S2 to step S9: NO, the lawn mower 10 executes the cutting of the grass in the energy saving mode (the first phase relationship) or the power mode (the second phase relationship) corresponding to the phase relationship that was automatically set in step S2.

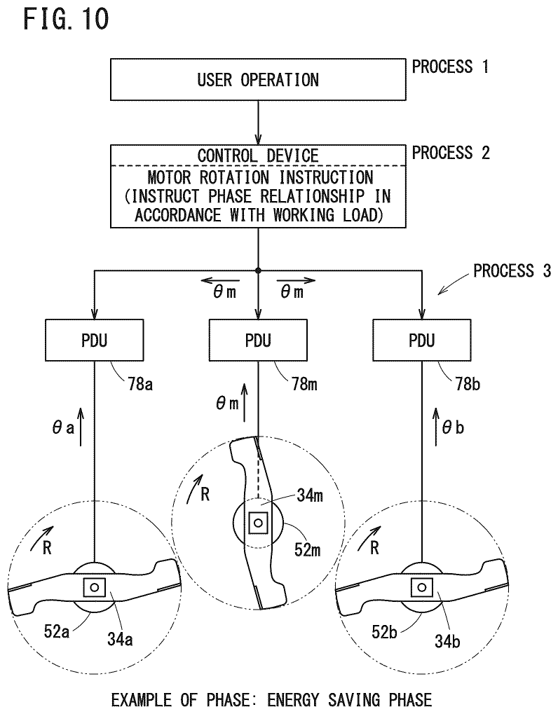

FIG. 10 is an explanatory diagram briefly illustrating an example of operations of the lawn mower 10 that is capable of automatically or manually switching between the energy saving mode and the power mode disclosed in the above-described embodiment.

In a Process 1, in the case that the control device 50 detects that a user operation has been performed by the operator or the like, then in a Process 2, the operator or the control device 50 imparts with respect to the working motors 52 (52a, 52b, and 52m) a rotation instruction for the first phase relationship or the second phase relationship in accordance with the workload.

Furthermore, the operator can also impart the rotation instruction for the desired phase relationship by operating the phase control switch 31c, based on a workload determination result being displayed on a display device (not shown) or the like by the control device 50.

In a Process 3, the motor driver (PDU) 78 (78a, 78b, and 78m) and the working motors 52 (52a, 52b, and 52m) share with the first slave motor 52a and the second slave motor 52b the rotational position information Om of the master motor 52m.

For example, in the case that the workload is light, and the rotation instruction is imparted in the first phase relationship (the energy saving mode) shown in FIG. 10, the speed of the working blades 34 (34a, 34b, and 34m) is controlled in a manner so that the slave blades 34a and 34b on both sides of the master blade 34m are shifted in phase by 90 degrees (with a phase difference of 90 degrees) and the rotation thereof is maintained.

The description provided above is a brief description of an example of operations of the lawn mower 12 according to an embodiment that is capable of automatically or manually switching between the energy saving mode and the power mode.

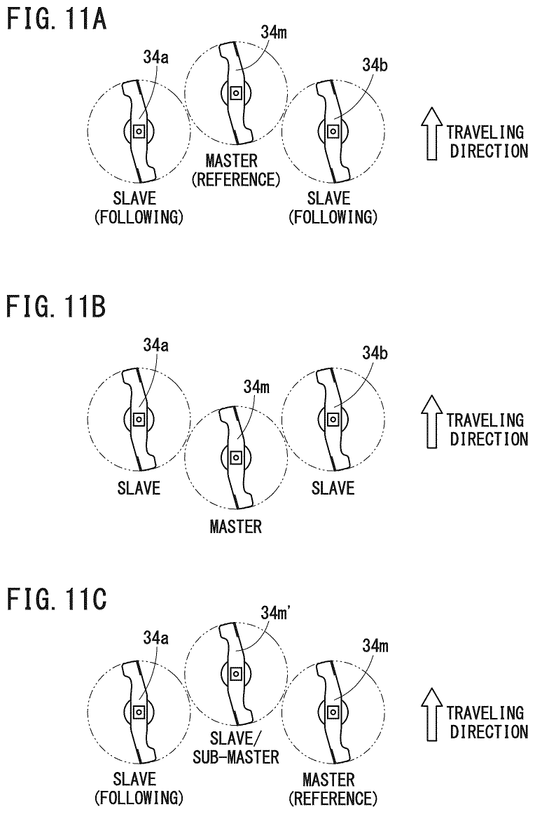

FIG. 11A to FIG. 11C are schematic plan views showing examples of the arrangement of the three working blades 34.

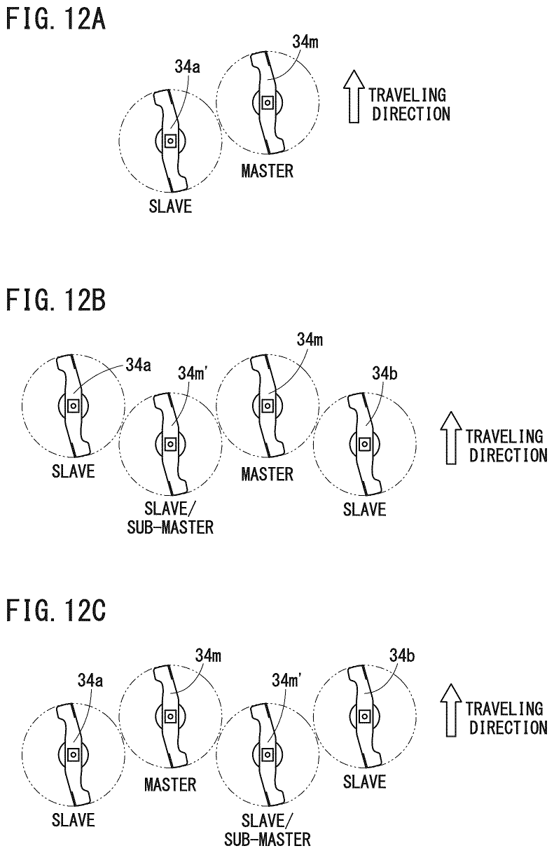

FIG. 12A to FIG. 12C are schematic plan views showing examples of the arrangement of two or four of the working blades 34.

FIG. 11A is an explanatory diagram of a blade arrangement according to an embodiment in which the centrally positioned master blade 34m is positioned in the traveling direction more forwardly than the adjacent slave blades 34a and 34b that rotate in following relation thereto.

The arrangement of the blades may be modified in the following manner. FIG. 11B shows the blade arrangement according to an Exemplary Modification 1, in which the centrally positioned master blade 34m is positioned more rearwardly in the traveling direction than the slave blades 34a and 34b which are adjacent to and rotate in following relation thereto.

FIG. 11C shows the blade arrangement according to an Exemplary Modification 2, in which the master blade 34m is arranged at one end part in the vehicle widthwise direction, which in the present example, is a right end part (may also be a left end part). In this case, a slave/sub-master blade 34m′ is rotated in synchronism with the master blade 34m, and the slave blade 34a is rotated in synchronism with the slave/sub-master blade 34m′.

FIG. 12A shows the blade arrangement according to an Exemplary Modification 3, which is made up from two of the blades 34, with the master blade 34m being positioned more forwardly in the traveling direction than the slave blade 34a, which is adjacent to and rotates in following relation to the master blade 34m. In this case, the slave blade 34a is disposed on a rear left-hand side of the master blade 34m, however, the slave blade 34a may also be disposed on a rear right-hand side of the master blade 34m.

FIG. 12B shows the blade arrangement of an Exemplary Modification 4, in which four of the working blades 34 are arranged in a zigzag pattern with respect to the traveling direction, sequentially in order, from the right side, of the rearwardly positioned slave blade 34b, the forwardly positioned master blade 34m, the rearwardly positioned slave/sub-master blade 34m′, and the forwardly positioned slave blade 34a.

FIG. 12C shows the blade arrangement of an Exemplary Modification 5, in which four of the working blades 34 are arranged in a zigzag pattern with respect to the traveling direction, sequentially in order, from the right side, of the forwardly positioned slave blade 34b, the rearwardly positioned slave/sub-master blade 34m′, the forwardly positioned master blade 34m, and the rearwardly positioned slave blade 34a.

In the arrangement of the working blades 34 shown in FIG. 12B and FIG. 12C, for example, when described with reference to FIG. 12B, the slave blade 34b and the slave/sub-master blade 34m′ are rotated synchronously with respect to the master blade 34m, and the slave blade 34a is rotated synchronously with respect to the slave/sub-master blade 34m′.

The number of the working blades 34 may be greater than or equal to five.

The following supplementary notes are further disclosed in relation to the above-described embodiment.

### Supplementary Note 1

The lawn mower (10) according to the above disclosure includes the plurality of blades (34a, 34b, and 34m) each including the vane portion (144) on at least one end, the plurality of motors (52a, 52b, and 52m) configured to rotationally drive the blades, respectively, the rotational position sensor (66a, 66b, and 66m) configured to acquire respective rotational position information when the respective motors rotate, and at least one processor configured to execute the computer-executable instructions that are stored in the memory (51), wherein, by the computer-executable instructions being executed by the at least one processor, the lawn mower controls the plurality of motors in a manner so that the plurality of blades rotate while a phase relationship between the vane portions of mutually adjacent blades from among the plurality of blades is maintained at the predetermined phase angle.

In accordance with such a configuration, the respective motors that cause the respective blades to rotate are controlled in a manner so that the blades rotate while the phase relationship between the vane portions of the mutually adjacent blades of the lawn mower is maintained at the predetermined phase angle. Therefore, the rotational control of each of the blades is made accurate.

### Supplementary Note 2

In the lawn mower according to Supplementary Note 1, from among the plurality of blades, the master blade (34m) serving as the reference for the phase angle may be determined, and from among the plurality of motors, the rotational position information of the master motor configured to rotationally drive the master blade, which is acquired through the rotational position sensor (66m), may be transmitted to each of the drivers (78a, 78b) of the remaining slave motors (52a, 52b) configured to rotationally drive the slave blades (34a, 34b) that are the remaining ones of the blades.

In accordance with such a configuration, based on the transmitted rotational position information (θm) of the master motor, each of the drivers of the slave motors can accurately (precisely) cause the phases (θa, θb) of the slave blades that are rotationally driven by the slave motors to be controlled in following relation with respect to the phase (θm) of the master blade that serves as the reference.

### Supplementary Note 3

In the lawn mower according to Supplementary Note 2, in the case that the plurality of blades are disposed alongside in three sets in the widthwise direction of the machine body of the lawn mower that is perpendicular to the lengthwise direction of the machine body of the lawn mower, the blade positioned centrally may be set as the master blade.

In accordance with such a configuration, based on the rotational position information of the master motor that rotationally drives the master blade that moves along the lengthwise direction of the machine body of the lawn mower, it is possible to control the angle of rotation of the slave motors that rotationally drive the slave blades that exist on both sides of the master blade in the vehicle widthwise direction. Due to this control, the grass can be evenly cut from the left to the right.

### Supplementary Note 4

In the lawn mower according to Supplementary Note 1, in the case that the plurality of blades include the vane portions respectively on both ends of the blades, the predetermined phase angle may be determined in a manner so that the blades that rotate adjacent to each other maintains rotation in a state in which the vane portions of the blades are non-opposed to each other at all times.

In accordance with such a configuration, the predetermined phase angle is determined in a manner so that the adjacent blades maintain their rotation in a state in which the vane portions thereof are non-opposed to each other at all times. Therefore, during rotation thereof, the vane portions do not face toward each other in a positional relationship opposing one another, and interference between the air flows that occurs when the vane portions are in a positional relationship opposing one another can be reduced, pulsation of the motors can be suppressed, and the electrical power consumed by the motors can be reduced.

### Supplementary Note 5

In the lawn mower according to Supplementary Note 4, the predetermined phase angle may be determined to be 90 degrees.

In accordance with such a configuration, when the predetermined phase angle is determined to be 90 degrees, the positions of the air flows generated by the vane portions of the rotating blades that rotate adjacent to each other are maximally distanced from each other, and therefore, an impact of a collision between the air flows during rotation becomes extremely small, and a reduction in sound is realized. At the same time, the torque current in order to maintain the rotational speed of the motors becomes smaller. Fluctuations in the torque current can also be suppressed. This contributes to conservation of energy.

### Supplementary Note 6

In the lawn mower according to Supplementary Note 3, there may further be provided the working unit housing (82) in which the three sets of the blades are accommodated, wherein the working unit housing includes the upper wall (82U) and the side walls (82B, 82F, and 82S) connected to the upper wall, and the distance (DF) from each of the midpoints (83c and 83d) on the straight lines (83a and 83b) connecting the centers of rotation of the adjacent blades to the side wall (82F) on the front side is longer than the distance (DB) from the midpoints to the side wall (82B) on the rear side.

In accordance with such a configuration, within the space formed by the working unit housing, since the space in the front of the blades is larger than the space in the rear of the blades, the grass can be cut with good efficiency.

Although a description has been given in detail concerning the present disclosure, it is not intended that the present disclosure be limited to each of the embodiments described above. Within a range that does not depart from the essence and gist of the present disclosure, or within a range that does not depart from the content described in the claims and their equivalents, various additions, substitutions, changes, partial deletions, or the like can be made to such embodiments. Further, such embodiments can also be implemented together in combination. For example, in the embodiments described above, the order of each of the operations and the order of each of the processes are shown as examples, and the present disclosure is not limited to such operations and processes. The same applies to cases in which numerical values or mathematical expressions are used in the description of the aforementioned embodiments.

1. A lawn mower, comprising:
a plurality of blades each including a vane portion on at least one end;
a plurality of motors configured to rotationally drive the blades, respectively;
a rotational position sensor configured to acquire respective rotational position information when the respective motors rotate; and
at least one processor configured to execute computer-executable instructions that are stored in a memory,
wherein, by the computer-executable instructions being executed by the at least one processor, the lawn mower controls the plurality of motors in a manner so that the plurality of blades rotate while a phase relationship between the vane portions of mutually adjacent blades from among the plurality of blades is maintained at a predetermined phase angle.

2. The lawn mower according to claim 1, wherein:
from among the plurality of blades, a master blade serving as a reference for the phase angle is determined; and
from among the plurality of motors, rotational position information of a master motor configured to rotationally drive the master blade, which is acquired through the rotational position sensor, is transmitted to each of drivers of remaining slave motors configured to rotationally drive slave blades that are remaining ones of the blades.

3. The lawn mower according to claim 2, wherein, in a case that the plurality of blades are disposed alongside in three sets in a widthwise direction of a machine body of the lawn mower that is perpendicular to a lengthwise direction of the machine body of the lawn mower, the blade positioned centrally is set as the master blade.

4. The lawn mower according to claim 1, wherein, in the case that the plurality of blades include the vane portions respectively on both ends of the blades, the predetermined phase angle is determined in a manner so that the blades that rotate adjacent to each other maintains rotation in a state in which the vane portions of the blades are non-opposed to each other at all times.

5. The lawn mower according to claim 4, wherein the predetermined phase angle is determined to be 90 degrees.

6. The lawn mower according to claim 3, further comprising a working unit housing in which the three sets of the blades are accommodated,
wherein the working unit housing includes an upper wall and side walls connected to the upper wall, and
a distance from each of midpoints on straight lines connecting the centers of rotation of the adjacent blades to the side wall on a front side is longer than a distance from each of the midpoints to the side wall on a rear side.
